(19) United States
(12) Patent Application Publication
(10) Pub. No.: US 2010/0271834 A1
(43) Pub. Date: Oct. 28, 2010

(54) LED LIGHTING SYSTEM

(75) Inventor: Daniel Muessli, Singapore (SG)

Correspondence Address: KENING LI;PINSENT MASONS LLP, c/o FOUNTAIN LAW GROUP, INC, 18201 Von Karman Avenue, Suite 960, Irvine, CA, 92612, US

(73) Assignee: Future Tec (Hong Kong) Limited, Hong Kong (CN)

(21) Appl. No.: 12/765,866

(22) Filed: Apr. 23, 2010

(30) Foreign Application Priority Data
Apr. 24, 2009 (DE) 20 2009 006 088.8

(51) Int. Cl. F21V 21/096; F21V 21/002; F21V 29/00

(52) U.S. Cl. 362/398; 362/382

(57) ABSTRACT

A LED lighting system comprising one or more LED chips and a two part railing system. The two part railing system comprises a first rail and a second rail parallel to the first rail, wherein the first and second rails are thermally and electrically conductive, form an electric circuit with the one or more LED chips to supply power thereto, and are mechanically sturdy so as to support the one or more LED chips. The LED chip has a first connection connected electrically to the first rail, and a second connection connected electrically to the second rail. The LED chip is thermally connected to the first and second rails, such that heat dissipation and electrical connection are ensured via the mechanical connection.

### RELATED APPLICATIONS

This application claims priority to German patent application No. 20 2009 006 088.8 filed on Apr. 24, 2009, the entire disclosure of which is incorporated herein by reference.

### BACKGROUND OF THE INVENTION

1. Field of the Invention

The present invention is in the field of light emitting diode (LED) lighting devices and more particularly in the field of a mounting system for LEDs that combines electricity conducting, heat dissipation and mechanical support.

2. Description of Related Art

Light emitting diodes (LEDs) are increasingly used as light sources for various purposes. LEDs have higher efficiency in converting input power to light energy incandescent lighting systems. Compared with fluorescent light, LEDs have longer lifetimes, operate without noticeable flickering and humming, can be dimmed by reducing the operating current thereto, and do not require high voltage electronics.

Despite its efficiency, heat is generated by an LED during operation. Due to its compact designs, heat generated in a LED lighting device often concentrates in a small volume, potentially increasing the LED's operating temperature significantly. For example, a 10° C.-increase in temperature will shorten the lifetime of a silicone and gallium arsenide LED chip by a factor of 2.5-3. Thus, efficient removal of heat is important in LED-based lighting systems.

The compactness, efficiency and long life of LEDs are particularly desirable and makes LEDs well suited for many applications. However, a limitation of LEDs is that they typically cannot maintain a long-term brightness that is acceptable for middle to large-scale illumination applications. Although an increase of the electrical current supplied to an LED generally increases the brightness of the light emitted by the LED, increased current also increases the junction temperature of the LED, which may reduce the efficiency and the lifetime of the LED.

Therefore, in general, multiple LEDs as an assembly or a panel are required. In addition, multiple LEDs often need to be assembled together to achieve certain desired color and lighting effects. However, in the design and manufacturing of devices comprising multiple LEDs, heat dissipation, power supply to each LED, as well as providing mechanical support for the LEDs as well as their circuit boards, can be challenging. Specifically, LEDs are operated with a low supply voltage, typically 2-4 volts. In the range of application in light engineering, one ballast device, which adjusts the mains supply voltage (230V/120V) to the low voltage, is usually used for each LED. In addition, each LED light source usually has a separate heat sink system.

The present invention provides an elegant design to the above problem.

### SUMMARY OF THE INVENTION

The present invention provides a lighting system comprising one or more LED chips and a two part railing system. The two part railing system comprises a first rail and a second rail parallel to the first rail, wherein the first and second rails are thermally and electrically conductive, form an electric circuit with the one or more LED chips to supply power thereto, and are mechanically sturdy so as to support the one or more LED chips. The LED chip has a first connection connected electrically to the first rail, and a second connection connected electrically to the second rail. The LED chip is thermally connected to the first and second rails, such that heat dissipation and electrical connection are ensured via the mechanical connection.

In one embodiment, in the lighting system of the invention, the first or second connection of the one or more LED chips comprises a metal contact wing that can clamp on to the first or second rail. The rails are correspondingly shaped as tubes.

In one embodiment, in the lighting system of the invention, the first or second connection of the one or more LED chips comprises magnets and are made to be in contact with the first or second rail via magnetic forces. The rails may thus have a flat surface.

In another embodiment, the first or second rail or both may be hollow, and a cooling fluid may circulate therein to facilitate heat dissipation. The first or second rail or both may optionally or additionally comprise a fin or similar structure to increase its surface area and to facilitate heat dissipation.

In an embodiment, in the lighting system of the present invention, a resistor is provided between the first connection and the first rail; or between the second connection and the second rail.

A power supply for the lighting system of the present invention may be connected to the rails in the same way as the LED chip. Depending on the lighting needs of the user, a large number of LED chips may be mounted on the rails, and if addition power is needed, a power supply may be mounted on the rails among the LED chips.

In a specific embodiment, the rails are tube shaped and the contact wing is designed so as to clamp onto the tube-shaped rail.

The power supply voltage is preferably maintained at not more than 48 volts, or not more than 12 volts, or not more than about 5 volts.

### BRIEF DESCRIPTION OF THE DRAWINGS

FIG. 1 shows one embodiment of the present invention.

FIG. 2 illustrates the connection of the LED chip to the connection wings.

FIG. 3 is an exploded view of FIG. 2 showing the details of the connections.

FIG. 4A and 4B show another embodiment of the lighting system of the invention.

### DETAILED DESCRIPTION OF THE INVENTION

The invention is now described in more details below with reference to the attached drawings.

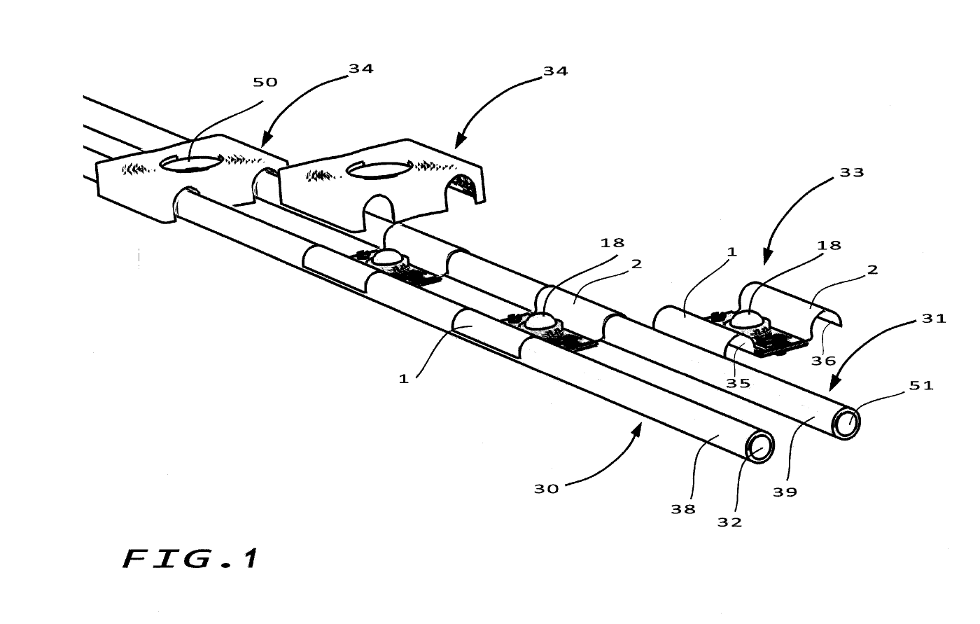

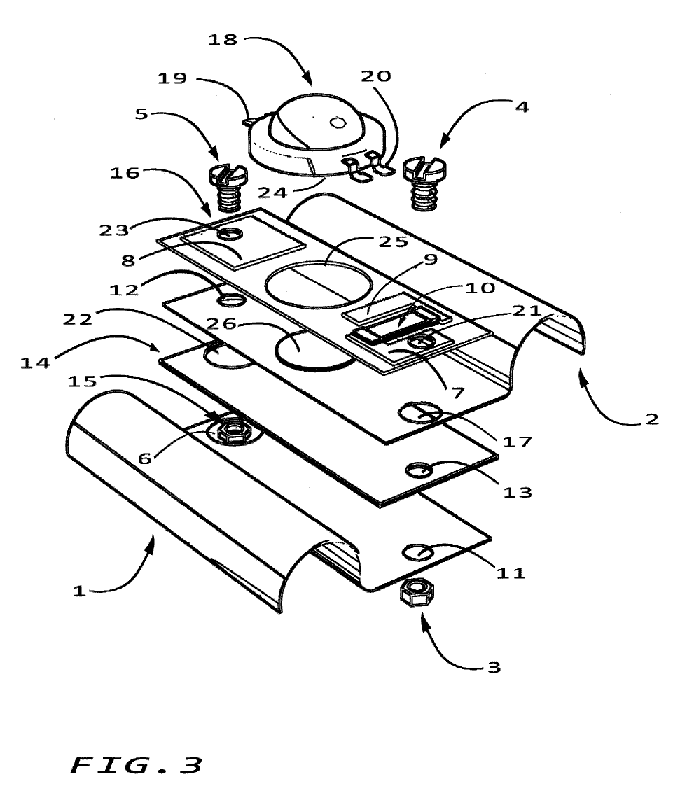

One embodiment of the present invention is shown in FIG. 1. An LED module 33 comprises an LED chip (18) which is connected electrically to two metal contact wings (1 and 2) which can clamp onto two parallel contact rails (30 and 31) respectively. The contact wings are constructed as clamps and have a curvature which is equal to or slightly less than the diameter of the contact rails. The contact wings surround the rails by a little more than 180° , so that they can be clamped onto them. The two wings are separated from each other by an isolation element 14 (see FIG. 3) which is made to be electrically isolating, but thermally conducting.

The parallel rails are conductive of both heat and electricity, and are mechanically sturdy enough to support multiple LED modules 33 clamped thereon. These rails constitute a part of the power supply and heat sink system of the LED lighting fixture of the present invention. Preferably, the rails are made of iron or steel. In one embodiment, the power supply and heat sink system rails can be in the form of a hollow tube, with cooling liquid running and circulating through the inner tube space 32 and 51. The power supply and heat sink system rails are in turn connected via a connection to a ballast.

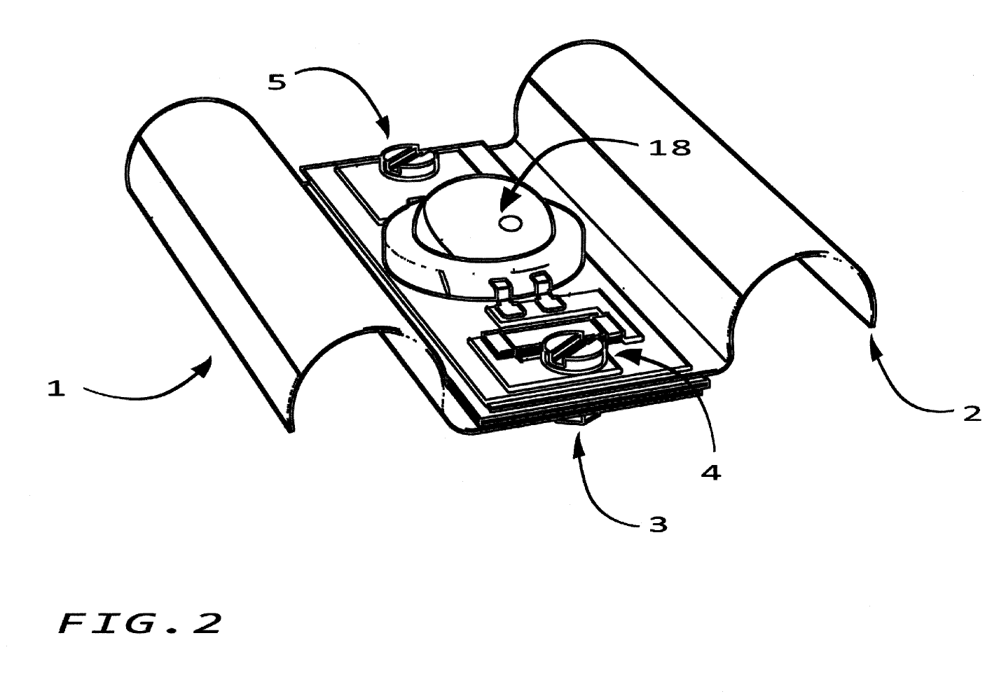

FIGS. 2 and 3 show the LED module in more detail. The LED chip is connected by connections 20 to a current-limiting resistor 10 which is sandwiched by two metal pate 7 and 9 mounted on PCB 16 to the connection. Metal plate 7 is connected via bolt 4 and nut 3 to contact wing 1. A hole 17 in contact wing 2, through which bolt 4 is inserted, is sufficiently big in size such that there is no contact between bolt 4 and contact wing 2. Hole 13 in the isolation element 14, and hole 11 in contact wing 1 are designed to fit onto bolt 4 snuggly such that heat and/or electric conduction are ensured.

The other connection 19 of LED chip to wing 2 is identical with the exception of the absence of a resistor. In other words, metal plate 8 is connected via bolt 5 and nut 15 to contact wing 2. A hole 6 in contact wing 1, through which bolt 5 is inserted, is sufficiently big in size such that there is no contact between bolt 5 and contact wing 1. Hole 22 in the isolation element 14, and hole 12 in contact wing 2 are designed to fit onto bolt 5 snuggly such that heat and/or electric conduction are ensured. In the drawing, hole 22 is shown to be bigger than the diameter of bold 5, which is also acceptable.

Hole 25 on the carrier substrate (not marked) allows the LED chip to be attached to wing 2 on the solder pad 26.

Heat from the LED chip is transferred to the contact wings, and on to the power supply and heat sink system rails. Thus, the LED module is thermally, electrically and mechanically connected to the power supply and heat sink system rail.

In one embodiment, the power supply and heat sink system rails may optionally be provided with cooling fins to increase surface areas for heat dissipation.

In an embodiment, the resistor, and optionally other electrical connection points, are thermally insulated from the heat sink components (e.g. contact win 2 in FIG. 1).

In another embodiment, the power supply and heat sink system rails may be flat, optionally equipped with fins. The LED module may be attached to the power supply and heat sink system rails via magnets while ensuring electrical and thermal connections.

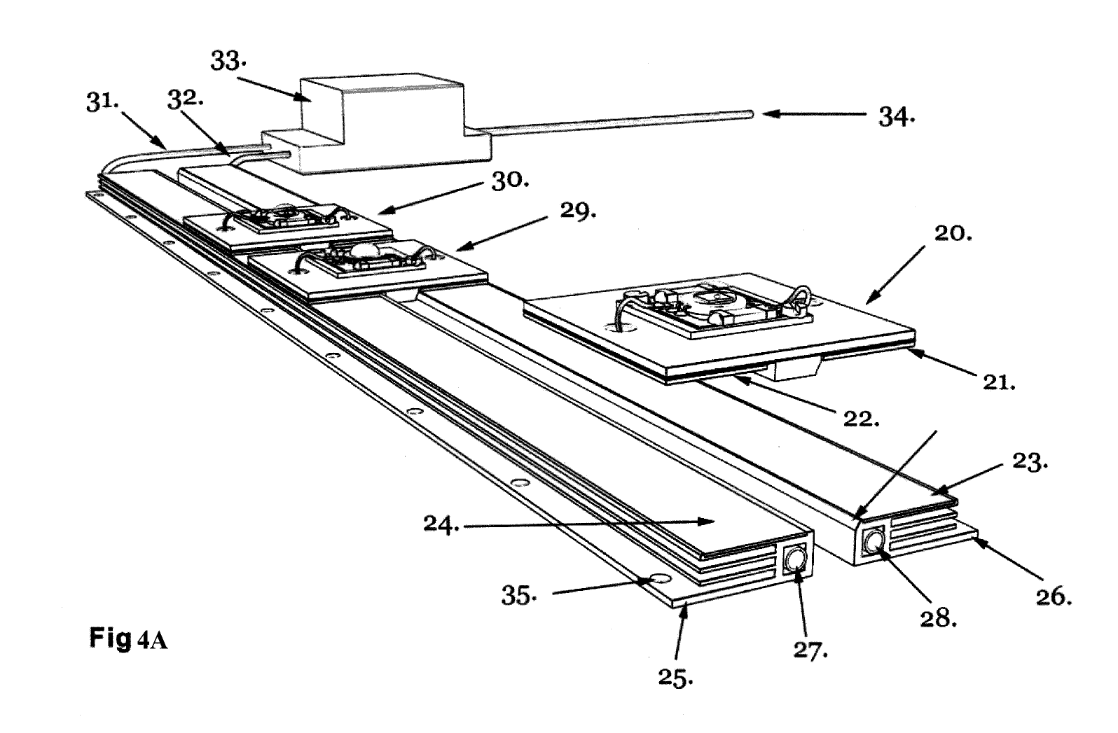

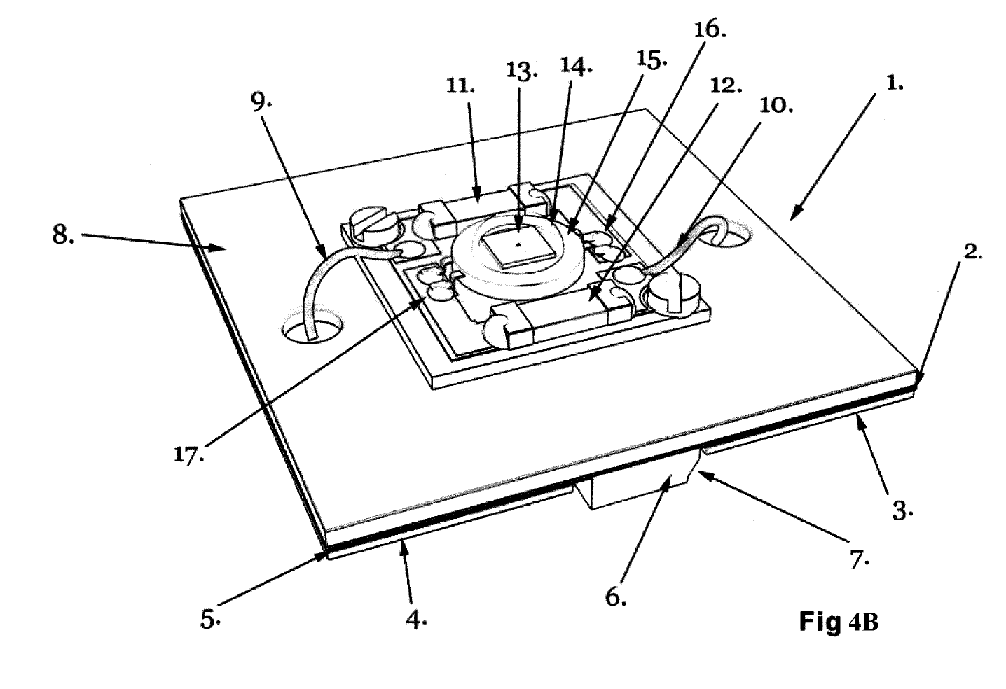

This embodiment is now described with reference to FIGS. 4 and 5 (the numbering of the various parts are independent of that in FIGS. 1-3), which is a perspective view of one embodiment of the module, and a perspective view of an element thereof, respectively.

FIG. 4 shows an LED module 1 with the actual LED chip 13 in the LED housing 15 enclosed in the lens 14 with connections 16, 17. The LED 13, 14, 15 is connected by a current-limiting resistor 11, 12 to the connection 16, 17. The resistor is connected on the other connection side via the connection 9, 10 to a (magnetic) contact plate 4. Heat from the LED chip 13 is transferred via the housing 15 to the carrier substrate 8, which in turn is isolated and connected by the insulator 5, 3 to the electric contact 4, 3. A central rail, via a flattened portion 7, provides for the LED module 1 to be inserted correctly into a mount (FIG. 5). Then the contact magnet 22, 21 connects the LED module 20 (1 in FIG. 4) to the contact rail 24, 23. Thus, the LED module 20, 30, 29 is thermally, electrically and mechanically connected to the power supply and heat sink system rail 25, 26. The power supply and heat sink system rail 25, 26 is connected electrically and thermally with a contact rail 24, 23. The power supply and heat sink system rail 25, 26 can also actively promote cooling via a liquid cooling tube 27, 28 in which a cooling liquid circulates. The power supply and heat sink system rail 25, 26 is in turn connected via a connection 31, 32 to a ballast 33 which is connected via the lead 34 to the mains power grid. The power supply and heat sink system rail 25, 26 preferably may have mounting holes 35 for mounting.

The present invention provides a design that combines the heat sink/cooling system, power supply and mount function. The cost to operate several LEDs is reduced considerably. Such a design provides a high current conduction cross-section thus very low electrical resistance; it is feasible to operate the LEDs with a low voltage (not more that 12 v, preferably in the 4-5 v range). This way, the relatively expensive ballasts can be replaced with a simple passive ballast which essentially consists of a ballast resistor.

The power supply voltage for the lighting system of the present invention preferably is 48 volts or less, such that no insulation is needed on the rails and the LED chips can be placed anywhere on the rails. Preferably, a power supply of 5 volts and less is used so that the LED module is protected against incorrect polarization or orientation (i.e. being mounted in a reverse direction) because the reverse voltage of a LED is typically 5 volts or more. This way, is a user incorrectly mounts the LED chip, the LED will not light, but no damage will result from this mistake, and the user merely needs to turn the LED chip around.

In addition, by the combination of the cooling, the mount, and the power supply, very user-friendly design applications can be made; so that the construction can be made with less components than conventional designs. In addition, the LED module can be replaced easily with simple handling by a non-expert.

The present invention allows for universal placement of the LEDs along the railing, and a user may add and remove additional LEDs as needed.

Advantageously, the present LED system is operated with 5 volts which has in turn the advantage that the inexpensive and widely available computer power supplies from the PC-industry can be used as ballasts. If needed, a new power supply can be added along the rails to ensure adequate supply of power.

The embodiments discussed above have illustrated certain inventive principles by showing specific embodiments. As noted, other structures may apply such principles in other ways. For example, in another embodiment, an LED module can connect to the rails bolts. Accordingly, it is envisioned that the fastening of the LED chips to the rails and parts incident thereto may have configurations and properties that differ substantially from the above specific examples.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of skill in the art based upon this disclosure. Accordingly, it should be understood that various features and aspects of the disclosed embodiments can be combined with or substituted for one another in order to form varying modes of the disclosed invention. Thus, the scope of the present invention herein disclosed should not be limited by the particular disclosed embodiments described above.

What is claimed is:

1. A lighting system comprising one or more LED chips and a two part railing system,
wherein the two part railing system comprises a first rail and a second rail parallel to the first rail,
wherein the first and second rails are thermally and electrically conductive, form an electric circuit with the one or more LED chips to supply power thereto, and are mechanically sturdy so as to support the one or more LED chips;
wherein the LED chip has a first connection connected electrically to the first rail, and a second connection connected electrically to the second rail, and
wherein the LED is thermally connected to the first and second rails, such that heat dissipation and electrical connection are ensured via the mechanical connection.

2. The lighting system according to claim 1, wherein the first or second connection of the one or more LED chips comprises a metal contact wing that can clamp on to the first or second rail, or is in contact with the first or second rail via magnetic forces.

3. The lighting system according to claim 1, wherein the first or second rail or both are hollow, and a cooling fluid may circulate therein to facilitate heat dissipation.

4. The lighting system according to claim 1, wherein the first or second rail or both further comprise a fin structure to facilitate heat dissipation.

5. The lighting system according to claim 1, wherein a resistor is provided between the first connection and the first rail.

6. The lighting system according to claim 1, further comprising a power supply that can be connected to the rails in the same way as the LED chip.

7. The lighting system of claim 2, wherein the rails are tube shaped and the contact wing is designed so as to clamp onto the tube-shaped rail.

8. The lighting system of claim 1, wherein a power supply voltage is maintained at not more than 48 volts.

9. The lighting system of claim 1, wherein a power supply voltage is maintained at not more than 12 volts.

10. The lighting system of claim 1, wherein a power supply voltage is maintained at not more than about 5 volts.

11. The lighting system of claim 1, wherein the LED chip is held via a cardan metallic pivoting device which takes the temperature and the voltage together to the plug connection.
